(19) United States
(12) Patent Application Publication
(10) Pub. No.: US 2011/0281027 A1
(43) Pub. Date: Nov. 17, 2011

(54) Method of Making a Porous Polymer-Metal and Carbon-Metal Composites

(75) Inventor: Bryan D. Vogt, Chandler, AZ (US)

(73) Assignee: ARIZONA BOARD OF REGENTS, A BODY CORPORATE OF THE STATE OF ARIZONA , ACTING FOR AND ON BEHALF OF ARI, Scottsdale, AZ (US)

(21) Appl. No.: 13/127,777

(22) PCT Filed: Nov. 9, 2009
(86) PCT No.: PCT/US2009/063736

§ 371 Date: Jul. 22, 2011

Related U.S. Application Data
(60) Provisional application No. 61/113,438, filed on Nov. 11, 2008.

(51) Int. Cl. B05D 5/00; B05D 7/24; B05D 3/02; B82Y 30/00

(52) U.S. Cl. 427/226; 427/243; 977/779

(57) ABSTRACT

The invention provides a method for the self-assembly of organometallics within a sacrificial amphiphilic template in order to produce uniform mesoporous carbon composites coated with the organometallic component.

### RELATED APPLICATIONS

Not Applicable

### FEDERALLY SPONSORED RESEARCH OR DEVELOPMENT

Not Applicable

### BACKGROUND OF THE INVENTION

Transition metal ions and transition metal oxides have been used in applications such as catalysis, photocatalysis, sensors and the preparation of electrodes to name but a few applications. A high surface area support for catalysis is one critical consideration in enhancing efficiency and cost-effectiveness of catalysis. Porous solids are particularly attractive due to their intrinsic high internal surface area. (Corma et al., Chemical Reviews 1997, 97 (6), 2373-2419) Porous materials are divided into three classes based upon their size: micropores, mesopores and macropores; according to IUPAC nomenclature correspond to <2 nm, 2-50 nm and >50 nm respectively.

Mesoporous frameworks, such as zeolites, enable efficient catalytic cracking of petroleum feedstock. Synthetic alternatives to zeolites with large cage pores have been developed during the past decade. (Beck, et al., Journal of the American Chemical Society 1992, 114 (27), 10834-10843; Kresge, et al., Nature 1992, 359 (6397), 710-712; Zhao et al., Science 1998, 279 (5350), 548-552) The incorporation of precious metals on porous supports are commonly utilized in the catalytic transformation of petroleum feedstocks into value added products. (Beller et al., Journal of Molecular Catalysis A Chemical 1995, 104 (1), 17-85; Howard et al., Catalysis Today 1993, 18 (4), 325-354) These porous materials are also useful in fuel cell performance (Song et al., Catalysis Today 2002, 77 (1-2), 17-49) and production of biofuels (Huber et al., Chemical Reviews 2006, 106 (9), 4044-4098).

In recent years the preparation of such metal ions and oxides on porous supports has received significant attention. The generalized synthesis scheme for these materials allows for facile substitution in the oxide framework to create diverse materials with large internal surface area. (Yang et al., Nature 1998, 396 (6707), 152-155) Deposition of metals within these supports further extends their capabilities for catalytic applications. (Ying et al., Synthesis and applications of supramolecular-templated mesoporous materials. Angewandte Chemie-International Edition 1999, 38 (1-2), 56-77)

However, while it is widely recognized that organized mesoporous materials that contain transition metals will be useful in many applications, metal ions tend to have high surface energies which make them favor low surface areas. This presents a challenge when forming metal ion composites in surfactants. Moreover the presence of high concentrations of metal ions yields an unpredictable pore size for the mesoporous structures. Moreover, the post-synthesis deposition of the metal ions within the mesopores limits the ability to precisely control the deposited metal. Significant improvements in the catalytic efficiency could be realized through improved control of the catalyst dispersion.

The synthesis of mesoporous materials is typically solution based (sol gel). (Barton et al., Chemistry of materials 1999, 11 (10), 2633-2656; Brinker et al., Current Opinion in Colloid & Interface Science 2006, 11 (2-3), 126-132) Unfortunately, the synthesis of aluminosilicate mesoporous materials using surfactant templates typically yields only mildly acidic surfaces as a result of the amorphous framework. (Armengol et al., Journal of the Chemical Society-Chemical Communications 1995, (5), 519-520) Efforts have been made to fabricate crystalline frameworks while maintaining the well defined pores. (Yang et al., Nature 1998, 396 (6707), 152-155; Crepaldi et al., New Journal of Chemistry 2003, 27 (1), 9-13) However in many cases, crystallization of the metal oxide leads to collapse of the mesopores.

Mesoporous materials are attractive as supports for metal catalysts. (Corma et al., Chemical Reviews 1997, 97 (6), 2373-2419; De Vos et al., Chemical Reviews 2002, 102 (10), 3615-3640) In this case, dispersion of the catalytic specie is desired over the support surface. The sol gel approach whereby self-assembly of the surfactant template and condensation reaction of the metal oxide precursor occur simultaneously does not generally provide a simple route to directly modify the internal pore surfaces.

An alternative approach to catalytically active mesoporous materials is postsynthesis modification of the mesoporous framework. (Ying et al., Synthesis and applications of supramolecular-templated mesoporous materials. Angewandte Chemie-International Edition 1999, 38 (1-2), 56-77; Mehnert et al., Chemical Communications 1997, (22), 2215-2216) The incipient wetness technique (Luan et al., Chemistry of Materials 1999, 11 (12), 3680-3686) has been applied successfully to the modification of mesoporous silica surface with catalytic metals such as Pt and Pd. However, the deposition within the pores is generally uneven and leads to variability in the pore dimensions (thus modifying the transport properties within the support).

Control of the deposition is insufficient to maximize the utilization of the catalyst. To overcome these difficulties in the synthesis of mesoporous materials with controlled catalytic surfaces, new synthetic schemes are necessary. One successful route utilizes self-assembled monolayers with single reactive functionality towards the mesoporous wall framework. (Brunel, Microporous and Mesoporous Materials 1999, 27 (2-3), 329-344) The limited reactivity of the functional group enables uniform coverage of the pores and excellent utilization of the new chemistry for the task at hand. One example from this approach was able to create these monolayers within mesoporous silica in order to remove mercury contamination from water. (Feng et al., Science 1997, 276 (5314), 923-926) However, this approach is difficult to implement for the controlled placement of many catalytic species that would be of interest for petrochemical synthesis such as Ru, Pd, and Pt.

Thus there remains a need for additional methods for the preparation of mesoporous materials in which there are uniform pores coated with the metal catalyst of interest.

### BRIEF SUMMARY OF THE INVENTION

The present application provides a method control the metal quantity on the pore surfaces based upon interfacial thermodynamics is proposed. This method could provide significant improvements in metal utilization/dispersion in catalysis. The synthetic route involves utilization of preformed block copolymer (or non-ionic surfactant) template containing an organometallic and a molecule that is crosslinkable and carbonizable. The crosslinking can be performed by thermal treatment and/or exposure to vapors of a reactive species (such as formaldehyde). The template is removed thermally in an inert atmosphere (such as nitrogen or argon) and remaining material is converted to a carboneous form and metal particles. This yields a mesoporous inorganic support with pore walls decorated by the catalytic metal of interest.

The invention relates to a method of making a metal nanoparticle carbon hybrid which comprises preparing a composition comprising a block copolymer, an organometallic compound, a carbon precursor, a catalyst and a suitable polar solvent. This initial composition is then either formed into droplets, or the solvent is evaporated, or more preferable, this composition is used to coat a suitable substrate to obtain a film of the composition. The composition is then treated in order to cross-link the carbon precursor. The cross-linked carbon precursor-block copolymer composition is then subjected to pyrolysis to produce a mesoporous metal nanoparticle-carbon hybrid comprising pores coated with component.

The copolymer may be any block copolymer that has a difference in the polarity between the segments. These include diblock, triblock, pentablock, and miktoarm copolymers. Preferably the copolymer is a block copolymer is selected from the group consisting of poly(styrene-block-methyl methacrylate), poly(methylacrylate-co-dimethyl amino ethyl methacrylate-block-isoprene), a poly(ethylene oxide-block-propylene oxide-block-ethylene oxide) (Pluronic®) block copolymer, poly(ethylene oxide-block-alkyl) (Brij®) surfactants, poly(ethylene oxide-block-styrene), poly(ethylene oxide-block-isoprene) poly(ethylene oxide-block-butadiene) or poly(ethylene oxide-block-styrene).

The carbon precursor used to prepare the mesoporous carbon is preferably selected from the group consisting of phenol, resorcinol, phloroglucinol, mesophase carbon pitch, fufuryl alcohol, polyacrylonitrile, co-polymers of polyacrylonitril and mixtures thereof. In some embodiments, the carbon precursor is an aldehyde or formaldehyde condensation polymer or oligomer of phenol, resorcinol, phloroglucinol and mixtures thereof.

The polar solvent may be any solvent that is used with copolymers described. Preferably the polar solvent is selected from the group consisting of tetrahydrofuran, methanol, ethanol, propanol, butanol, propylene glycol methyl ether acetate, water, cyclohexanone and mixtures thereof.

The mesoporous carbon particles described herein are prepared with organometallic components that will be useful in a wide variety of catalytic applications. Such organometallic agents include for example metal catalyst such as those selected from the group consisting of vanadium, platinum, palladium, cerium, copper, zinc, molybdenum, niobium, cobalt, nickel, rubidium, silver, gold, iridium and iron. The ligands attached_to these metal centers are chosen to be stable in the solvent. Additionally, ligand choice can impact the size of the metal particles. Relatively weak ligand-metal interactions, such as in silver acetylacetonate, yield large metal particles, while thermally stable organometallic compounds, for example dimethylpalladium(II) triazacyclononane, produce smaller particles.

The initial solution can be evaporated into a solid structure, made into aerosol particles or can coat a substrate using any coating method typically used for template coating of polymers and includes methods such as spin coating, blade coating, spray coating, ink jet printing, dip coating.

The carbonizable components are crosslinked and cured using methods which comprise subjecting the film of the composition to elevated temperature with or without a vaporized reactant, for example formaldehyde, and for a time suitable to achieve sufficient cross-linking to hold the morphology of the film in place. For example, the composition is reacted with formaldehyde at 100° C. for a suitable period of time, for example, the composition subjected to formaldehyde vaporization for approximately 4 hours.

The crosslinking step is followed by pyrolysis to effect carbonization of the composite. In exemplary embodiments, the pyrolysis comprises reacting the composition in a Nitrogen atmosphere to a temperature of from 400° C. to 800° C. for a period of time sufficient to achieve pyrolysis. More particularly, the pyrolysis comprises transferring the composition to a nitrogen atmosphere and elevating the temperature of the atmosphere to 400° C. in 0.5° C./min increments and maintaining the composition at 400° C. for at least 3 hours. In exemplary embodiments, the pyrolysis step involves, after the at least 3 hours elevating the temperature to 800° C. at 5° C./min and holding the composition at 800° C. for at least 2 hours.

In specific examples, the initial composition used in the method comprises from about 4 wt % to about 6 wt % block copolymer.

In other embodiments, the initial composition used in the method comprises from about 1 wt % to about 3 wt % organometallic compound.

In still other embodiments, the initial composition used in the method comprises from about 2 wt % to about 6 wt % carbon precursor.

In yet other embodiments, the initial composition used in the method comprises from about 0.1 to about 0.2 wt % acid catalyst, p-toluenesulfonic acid.

In still further embodiments, the initial composition used in the method comprises from about 86 wt % to about 90 wt % solvent.

In a particular example, the invention provides a method of making a metal nanoparticle-carbon hybrid comprising preparing a solution comprising about 4 to about 6 wt % block copolymer, about 1 to about 3 wt % organometallic compound, about 2 to about 6 wt % carbon precursor; about 0.1 to about 0.2 wt % catalyst and about 86 to about 90 wt % suitable polar solvent; coating the composition on a suitable substrate to obtain a film of the composition; cross-linking the carbon precursor to the block copolymer; and subjecting the cross-linked carbon precursor-block copolymer composition to pyrolysis to produce a mesoporous metal nanoparticle-carbon hybrid comprising pores coated with the organometallic component.

In still another embodiment there is provided a method of making a metal nanoparticle carbon hybrid comprising preparing a composition comprising a block copolymer, an organometallic compound, a carbon precursor, a catalyst and a suitable polar solvent and forming droplets of the composition. The droplets are then subjected to a cross-linking step. The cross-linked composition is then pyrolysed to produce a mesoporous metal nanoparticle-carbon hybrid particles comprising pores coated with metal nanoparticles.

In still another embodiment there is provided a method of making a metal nanoparticle carbon hybrid comprising preparing a composition comprising a block copolymer, an organometallic compound, a oligomeric carbon precursor that is self-crosslinkable, and a suitable polar solvent. The solution is coated onto the surface of a non-planar speciman via dip coating. The carbon precursor is crosslinked at 120° C. and then pyrolysed to produce a mesoporous metal nanoparticle-carbon hybrid coating.

In still another embodiment there is provided a method of making a metal nanoparticle carbon hybrid comprising preparing a composition comprising a block copolymer, an organometallic compound, a oligomeric carbon precursor that is self-crosslinkable, inorganic metal oxide nanoparticles, and a suitable polar solvent. Any of the prior processing can be used to create a hybrid mesoporous material consisting of metal nanoparticles in a carbon-metal oxide matrix.

These and other features of the invention are discussed in further detail below.

### BRIEF DESCRIPTION OF SEVERAL VIEWS OF THE DRAWINGS

FIG. 1: Schematic of the predicted partitioning of organometallic molecules during self assembly of the surfactant structure directing agent.

FIG. 2: FE-SEM of porous silica with interconnected pores formed using TEOS and water vapor templated by a block copolymer/PHOSt blend doped with a photoacid generator.

FIG. 3: Potential heterogeneous catalyst geometries using coatings. The light gray represents the mesoporous film within capillary tubes (left) or on top of porous membrane. The inset at top illustrates the nanostructure of the mesoporous coating, containing both meso- and micro-pores with metal (open black circles) decorating the surface of the mesopores.

FIG. 4: XRD profile of a mesoporous silicate formed using a Brij56/PHOSt template and TEOS as the silicate source in the vapor phase.

FIG. 5: A (top) Sorption isotherm for mesoporous silica film. B. (bottom) Calculated pore size distribution from EP.

FIG. 6: TEM cross section of a mesoporous silica film.

FIG. 7: SEM cross section of a mesoporous carbon film doped with Co nanoparticles formed in-situ.

FIG. 8: (A) STEM image of approximately 20 nm wet grown silicon oxide layer on a silicon wafer. (B) EDS compositional scan corresponding to the line in the STEM image for both silicon and oxygen atoms.

FIG. 9: Copper organic molecules to be examined to determine impact of ligand on interfacial segregation. The variety of chemistries will enable an understanding of interactions that could hinder the efficient loading of metal at the pore wall using this method. All compounds [1—Copper II Acetate, 2—Copper II Dimethyldithiocarbamate, 3—Copper II Formate, 4—Copper II 2,4-pentanedionate, 5—Copper II 8-Hydroxyquinolinate] are reported to be moisture stable.

### DETAILED DESCRIPTION OF THE INVENTION

The present invention provides a method to control the metal quantity on the pore surfaces based upon interfacial thermodynamics of the mesoporous structure formation. This method provides significant improvements in metal utilization/dispersion in catalytic applications. In general terms, the methods provided herein involve the use of a preformed block copolymer template containing an organometallic component that is segregated to the interface between the tethered segments and a small molecule that is crosslinkable and carbonizable; subsequent modification of the template by an formaldehyde introduced through the vapor phase and removal of the organic phase yields a mesoporous inorganic support with pore walls decorated by the catalytic metal of interest.

The present invention provides a method of controlling the distribution of catalytic species within mesoporous materials. Instead of the traditional cooperative self-assembly with reaction route to synthesis mesoporous materials, a preformed template approach is used. (Nishiyama et al., Chemistry of materials 2003, 15 (4), 1006-1011; Pai et al., Science 2004, 303, 507-510) In this approach, self-assembly and reaction are decoupled, thereby enabling an improved control on the organization of the mesostructure.

Typically, an amphiphilic surfactant is cast into a film and then the reactive precursors are delivered into the film either through their vapor pressure (Nishiyama et al., Chemistry of materials 2003, 15 (4), 1006-1011; Tanaka et al., Journal of the American Chemical Society 2004, 126 (15), 4854-4858) or by dissolution in supercritical fluids (Pai et al., Science 2004, 303, 507-510; Pai et al., Advanced Materials 2006, 18 (2), 241-+). In the present invention, this templating scheme is modified whereby a small quantity of an organometallic compound is directly added to the template solution containing the block copolymer (surfactant), the carbon precursor (e.g., resorcinol) and an acid catalyst. The carbon precursor in this composition will segregate to the more hydrophilic domains of the block copolymer.

At low loadings concentration, the organometalic compound will preferentially segregate to the interface between hydrophilic and hydrophobic segments due to thermodynamic considerations. This is illustrated in FIG. 1. There are numerous reports of segregation of molecules to interfaces to support that the organometallic will segregate according to this projection. For example, moisture is known to accumulate at buried polymer interfaces. (Vogt et al., Langmuir 2004, 20, 5285-5290; Wu et al., Polymer Engineering and Science 1995, 35 (12), 1000-1004) Nanoparticles similarly assemble at liquid-liquid interfaces. (Lin et al., Science 2003, 299 (5604), 226-229) Even a neutral (non-selective) solvent for the segments of a block copolymer has a tendency to slightly accumulate at the tethered junction interface. (Lodge et al., Macromolecules 1997, 30 (20), 6139-6149) Nanoparticles are also known to aggregate near the tethering point between the two segments. (Lin et al., Nature 2005, 434 (7029), 55-59)

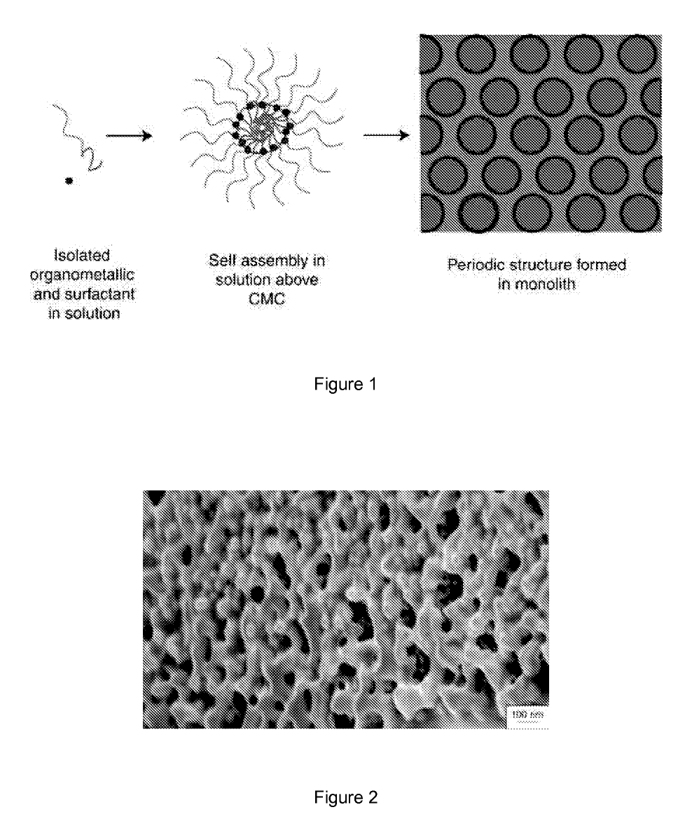

As shown in FIG. 2, a photoacid generator will preferentially segregate to the interface of a polymersurfactant blend during phase separation. Exposure to UV light and tetraethylorthosilicate vapor generates a polymer silica nanocomposite. Removal of the organic phases yields a porous structure (FIG. 2) that can be controlled by kinetically trapping the morphology during phase separation. Rapid quenching into the glass shortly after crossing into the spinodal enables small pore sizes. The segregation of the photoacid to the interface and not simply preferentially into domains for one of the compounds was tested by variation of the blend composition between the block copolymer and the homopolymer. At low homopolymer loadings, small isolated silica structure are formed, consistent with phase separation from highly asymmetric blend; however, a Bragg peak corresponding to the domain size of the block copolymer is observed in XRD. This is consistent with interfacial aggregation with selective diffusion of the photoacid into the block copolymer. The photoacid generator is of a similar size and organic chemistry to some organometallics of interest, so it demonstrates that it is possible to preferentially load polymer-polymer interfaces as proposed.

In addition, for nanoparticle assembly within block copolymers, the surface chemistry of the nanoparticle can be utilized to control its location. (Kim et al., Macromolecules 2008, 41 (2), 436-447) Therefore, it is likely that the ligands will be critical to controlling the location of the organometallic within the polymeric template. Additionally, the association of organometallics with certain polymeric moieties is well known; these interactions have been used to fabricate well defined polymer-metal nanocomposites using poly(styrene-block-vinyl pyridine). (Antonietti et al., Advanced Materials 1995, 7 (12), 1000-&; Sohn et al., Chemistry of Materials 1997, 9 (1), 264-269) Thus, pyridine and carboxylic acid containing block copolymers will be avoided for the controlled placement of the metal within the template.

As diffusion of reactive species through the preformed template is required to convert the polymeric template into a rigid inorganic porous material, considerations regarding manufacturability of this process are necessary. Two common geometries for catalytic supports are micron sized particles and film coatings. In both cases, the diffusion length to modify the template to the desired inorganic support is only several microns; we have demonstrated facile fabrication of approximately 1 μm thick mesoporous silica and carbon films using preformed templates. (Li et al., Journal of Physical Chemistry C 2007, submitted) Although particles are feasible through aerosol formation of polymeric templates and subsequent modification in a fluidized bed, (Hakim et al., Journal of the American Ceramic Society 2006, 89 (10), 3070-3075) film fabrication and characterization are more straightforward and will be utilized in this project for proof of concept.

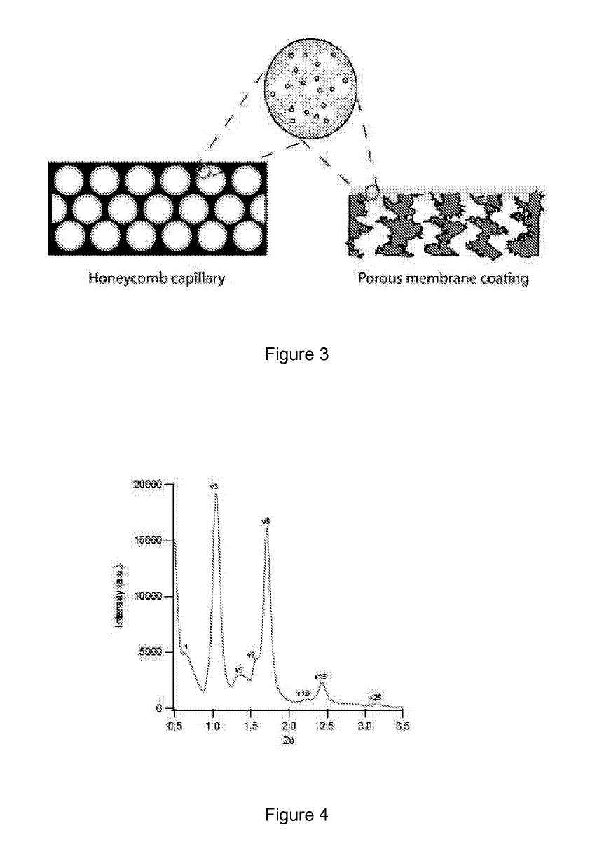

FIG. 3 illustrates two potential application routes for these film materials in heterogeneous catalysis using capillary tube or membrane geometries.

With these considerations, several fundamental questions regarding the viability of using organometallic doped polymeric templates to synthesize mesoporous materials with (catalytic) metals localized in a thin layer at the pore surfaces can be addressed.

In the present invention it is demonstrated for the first time that mesoporous carbons can be formed that are coated with organometallic compounds where the organometallic compound is part of the initial solution that is used to form the mesoporous carbon structure. Methods of making mesoporous carbons lacking such organometallic agents have been shown (Wang, Langmuir 2008 24 7500-7505) but those conditions employed highly acid conditions and the fidelity of the pores in the presence of organometallic components cannot be predicted.

In contrast, the present invention is directed to a method of making metal nanoparticle-carbon hybrids comprising taking an initial solution that contains a block copolymer, organometallic compound, carbon precursor; catalyst and suitable polar solvent and preparing either a film coating or an aerosolized particle from the composition. The film or the aerosolized droplets are then subjected to conditions which cross link the composition. In exemplary conditions, such cross-linking involves subjecting the film or aerosolized droplets to formaldehyde vapor at a suitable temperature and time (e.g., 100° C. for 4 hours. The cross-linked composition is then subjected to pyrolysis. Once the pyrolysis has occurred the composition produced has uniform mesoporous appearance in which the carbon pores have formed that are uniformly coated with a thin layer of the organometallic component. For example, the pyrolysis is achieved by placing the composition in a nitrogen atmosphere and heating to a temperature of 400° C. (e.g., at an increase of 0.5° C./min) for at least 3 hours and after said at least 3 hours elevating the temperature to 800° C. at 5° C./min and holding said composition at 800° C. for at least 2 hours.

While the above discussion provides exemplary methods of forming pyrolysis and cross-linking conditions, the skilled artisan will understand that any methods of cross-linking and pyrolysis may be used.

The methods may be carried out with organometallic ions including but not limited to vanadium ion, platinum ion, a palladium ion, an cerium ion, copper ion, zinc ion, molybdenum ion, aluminium ion; titanium ion, niobium ion, cobalt ion, nickel ion, and rubidium ions. The concentrations of these ions in any given preparation method may be varied as long as the integrity of the pores formed is maintained. Monitoring the integrity of the compositions will use methods known to those of skill in the art and some are discussed in additional detail herein below. Typically, in the methods described herein, the initial solution for forming the mesoporous compositions will contain between about 0.5 wt % to about 10 wt % and more preferably between about 1% to about 3% organometallic ions.

The block copolymer may be any copolymer typically used as templates in synthesis. While exemplary embodiments use copolymers homopolymers also may be used. Block copolymers contain a linear arrangement of blocks, a block being a portion of a polymer molecule in which the monomer units have at least one constitutional (e.g., the chemical makeup of the block) or configuration (e.g., the arrangement of atoms in the blocks) feature that is different from the adjacent blocks. Under suitable conditions (e.g., temperature and/or concentration range) some block copolymers self-assemble into domains of predominantly the same/single block type.

Examples of homopolymers or individual blocks within a block copolymer include polymethacrylic acid, poly(acrylic acid), polyethylene oxide, polycaprolactone, poly(lactic acid), polycarbonates, polysiloxanes, polyacrylates, polyhydroxystyrenes and poly(vinyl alcohol). Block copolymers of multiples of these homopolymers are contemplated for use in the methods described herein. Examples of copolymers that can be used include poly(methylacrylate-co-dimethyl amino ethyl methylacrylate) and poly(methyl methacrylate)-co-poly(hydroxystyrene).

As described herein it may be necessary to include a catalyst for initiating the condensation of the metal oxide as part of the described method to produce metal nanoparticle-carbon hybrids. In exemplary embodiments, the catalyst is an acid catalyst such as p toluene sulfonic acid. Other catalysts are described in e.g., Sol-Gel Science: The Physics and Chemistry of Sol-Gel Processing, by C. J. Brinker and Scherer (Acad Press, San Diego, Calif., 1989).

In the methods described, the initial solution is prepared and coated onto a suitable substrate. Such substrates include, e.g., silicon wafers, glass sheets, polymer webs, silicon carbide, gallium nitride and the like. In the methods of the invention the solution is coated onto the substrate by e.g., spin coated, knife coating, bar coating, dip coating or other exemplary coating method to achieve a template that is uniformly coated to a desired thickness and composition level.

### Methods of Testing the Formed Mesoporous Compositions

In an exemplary embodiment, the general process will involve formation via spin coating of an organometallic containing amphiphilic polymer film containing resorcinol, cross linking by exposure to controlled vapor pressure of formaldehyde, and carbonization in nitrogen to remove the template and yield a mesoporous carbon decorated with a metal or metal oxide nanoparticles on the surface, depending upon the organometallic chosen. To minimize complications from interactions between the template and the organometallic leading to segregation into one domain, a template without strong interactions with the organometallics will be used. In exemplary embodiments, it has been seen that poly(styrene-block-methyl methacrylate) (PS-PMMA) does not strongly segregate the organometallic into either phase.

Throughout the processing steps, the structure of the film may be monitored using a suite of analytical tools. For example, the thickness and refractive index of the films will be assessed with spectroscopic ellipsometry. Incorporation of the organometallic into the template and removal of the organic template can be assessed from changes in the refractive index. The initial assessment of the distribution of the organometallic within the template can use x-ray diffraction (XRD); the large difference in Z between the metal center and the template will provide x-ray contrast. In such monitoring, no diffraction is observed in the neat polymeric template, but if there is significant segregation of the organometallic, then diffraction from the ordered structure would be observed prior to silica modification.

The morphology of the mesopores after carbonization will also be determined with XRD; FIG. 4 shows XRD profile from a templated mesoporous film. The film thickness of the mesoporous carbon cannot usually be determined with ellipsometry due to significant visible light adsorption of the film. However, the refractive index of film will be monitored. Capillary condensation can be used to determine the pore size distribution through changes in the refractive index (assuming a uniform material).

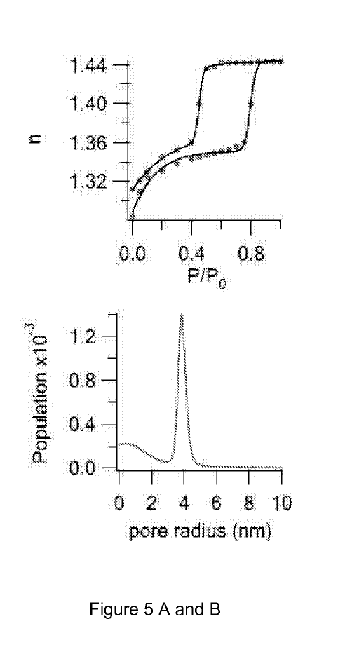

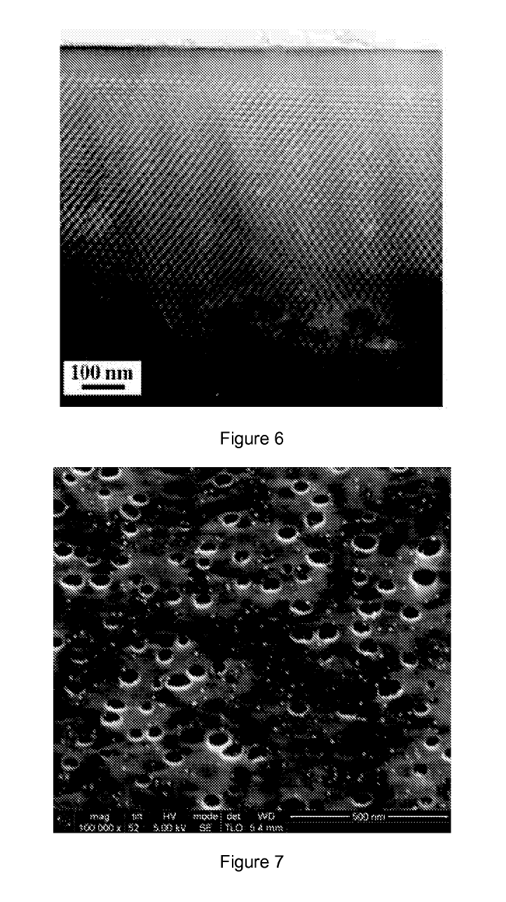

FIG. 5 shows the refractive index change from ellipsometric porosity and the corresponding pore size distribution for a mesoporous film. Since diffusion of the metal could occur during the calcinations and the high contrast between the pores and wall limit identification of the distribution of the metal, electron microscopy may be utilized to assess the morphology of the mesoporous films as well. Cross sectional TEM (see FIG. 6 as example) can be used to assess any thickness dependence of the metal distribution as well as provide a real space image for the morphology. The metal distribution should be easy to qualitatively determine as there is a large electron density difference between silica and most transition metals of interest for catalysis.

Preliminary results using PS-PMMA, resorcinol and a small concentration of Co(acac) show some promise as illustrated in FIG. 7. The initial loading of the resorcinol was too large, thus isolated micelles of the PS-PMMA were formed leading to a more disordered structure. However, the nanoparticles of Co formed in-situ appear to be segregated at the pore walls as hypothesized. Decrease the resorcinol loading is expected to yield well ordered structures.

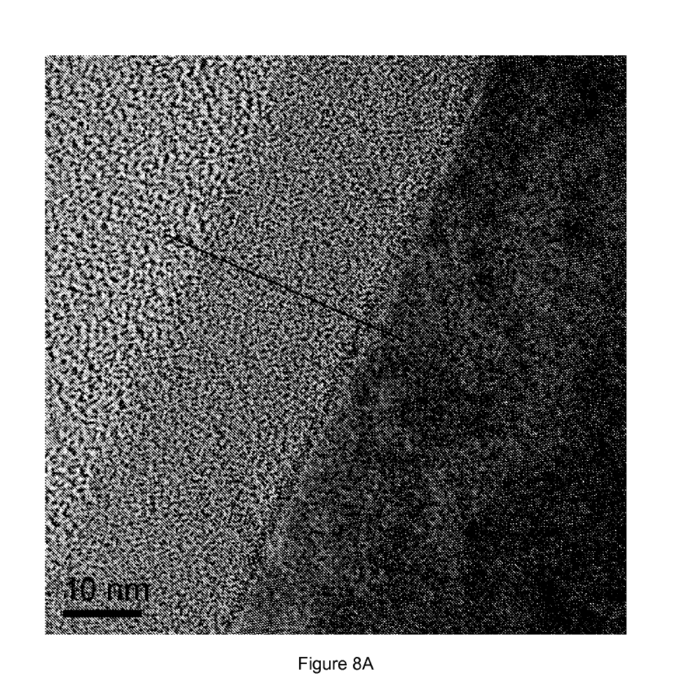

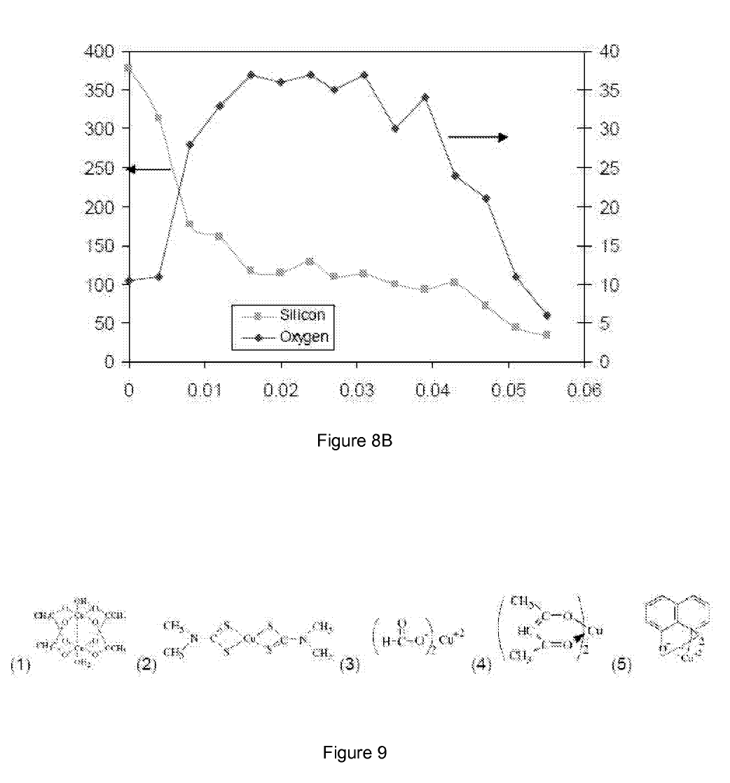

In order to accomplish this goal, the cross sections will also be assessed at higher magnification using STEM coupled with EDS. This provides a route to a line scan of the composition radially from the pore wall. This will quantify the distribution of elements within the porous film. An example of this high resolution compositional analysis is illustrated in FIG. 8 showing the cross section of a silicon oxide layer on a silicon wafer. These combined techniques will be able to assess the efficiency of the metal assembly at the interface.

To test the impact of ligand on the interfacial segregation, different organometallic compounds based on copper can be utilized. Although cuprous oxide is a relevant catalyst, this choice is primarily based upon the wide availability of numerous organo-copper compounds due to their utilization in CVD for microelectronics, such that water-insensitive compounds can be easily identified. FIG. 8 illustrates the chemical structures of readily available copper-based organometallics that will be examined in this work. Through this vast variation in chemical structure, limitations to efficient segregation of the organometallic to the eventual pore interface can be elucidated at constant concentration.

Having thus gained an understanding of how the ligand structure impacts the interfacial segregation, two cupric organometallics can be selected to explore more systematically; these will be the ‘worst’ and the ‘best’ performing from the fixed concentration study. The concentrations of these two molecules will be varied significantly (˜0% to ˜10%) within the template to determine how this impacts the metal distribution within the mesoporous support. If variation in the distribution is strongly non-linear in concentration, additional organometallic compounds may also be examined to provide better insight into this phenomenon.

A further objective is to examine the impact of the metal center on the assembly process. The exact metals will be dependent upon the prior results as ligands that enable segregation to the interface. For example if copper II 2,4-pentanedionate performs well, then other 2,4-pentanedionate based organometallics would be explored. Criteria for selection would include moisture stability (although the initial casting solution could be anhydrous using a solvent such as THF) and relevance to catalysis. Metals of interests would include Co, Pd, Pt, Ni, V, Ru as examples. This would test the universality of the method and provide considerations for choice of organometallic.

1. A method of making a metal nanoparticle carbon hybrid comprising:
a. preparing a composition comprising a block copolymer, an organometallic compound, a carbon precursor, a catalyst and a suitable polar solvent;
b. coating said composition on a suitable substrate to obtain a film of said composition;
c. cross-linking the carbon precursor;
d. subjecting the cross-linked carbon precursor-block copolymer composition to pyrolysis to produce a mesoporous metal nanoparticle-carbon hybrid comprising pores coated with said organometallic component.

2. The method of claim 1, wherein said block copolymer is selected from the group consisting of poly(styrene-block-methyl methacrylate), poly(methylacrylate-co-dimethyl amino ethyl methacrylate-block-isoprene), a poly(ethylene oxide-block-propylene oxide-block-ethylene oxide) (Pluronic®) block copolymer, poly(ethylene oxide-block-alkyl) (Brij®) surfactants, poly(ethylene oxide-block-styrene), poly(ethylene oxide-block-isoprene) poly(ethylene oxide-block-butadiene) or poly(ethylene oxide-block-styrene).

3. The method of claim 1, wherein the carbon precursor is selected from the group consisting of phenol, resorcinol, phloroglucinol, mesophase carbon pitch, fufuryl alcohol, polyacrylonitrile, co-polymers of polyacrylonitril and mixtures thereof or an aldehyde or formaldehyde condensation polymer or oligomer of phenol, resorcinol, phloroglucinol and mixtures thereof.

4. (canceled)

5. The method of claim 1, wherein the polar solvent is selected from the group consisting of tetrahydrofuran, methanol, ethanol, propanol, butanol, propylene glycol methyl ether acetate, water, cyclohexanone and mixtures thereof.

6. The method of claim 1, wherein said organometallic component is a metal ion catalyst selected from the group consisting of a vanadium, platinum, palladium, cerium, copper, zinc, molybdenum, niobium, cobalt, nickel, rubidium, silver, gold, iridium and iron.

7. The method of claim 1, wherein said coating comprises a method selected from the group consisting of spin coating, blade coating, spray coating, ink jet printing, dip coating.

8. The method of claim 1, wherein said cross-linking step comprises subjecting said film of said composition to formaldehyde vaporization at a temperature and for a time suitable to achieve said cross-linking.

9. The method of claim 7, wherein said composition is reacted with formaldehyde at 100° C. for approximately 4 hours.

10. (canceled)

11. The method of claim 1, wherein said pyrolysis comprises reacting said composition in a Nitrogen atmosphere to a temperature of from 400° C. to 800° C. for a period of time sufficient to achieve pyrolysis.

12. The method of claim 1, wherein said pyrolysis comprises transferring said composition to a nitrogen atmosphere and elevating the temperature of said atmosphere to 400° C. in 0.5° C./min increments and maintaining the composition at 400° C. for at least 3 hours.

13. The method of claim 12 comprising after said at least 3 hours elevating the temperature to 800° C. at 5° C./min and holding said composition at 800° C. for at least 2 hours.

14. The method of claim 1, wherein said composition of step (a) comprises from about 4 wt % to about 6 wt % block copolymer.

15. The method of claim 1, wherein said composition of step (a) comprises from about 1 wt % to about 3 wt % organometallic compound.

16. The method of claim 1, wherein said composition of step (a) comprises from about 2 wt % to about 6 wt % carbon precursor.

17. The method of claim 1, wherein said composition of step (a) comprises from about 0.1 to about 0.2 wt % catalyst.

18. The method of claim 1, wherein said composition of step (a) comprises from about 86 wt % to about 90 wt % solvent.

19. The method of claim 1 wherein said composition of step (a) further comprises inorganic metal oxide nanoparticles.

20. A method of making a metal nanoparticle-carbon hybrid comprising:
a. preparing a solution comprising about 4 to about 6 wt % block copolymer, about 1 to about 3 wt % organometallic compound, about 2 to about 6 wt % carbon precursor; about 0.1 to about 0.2 wt % catalyst and about 86 to about 90 wt % suitable polar solvent;
b. coating said composition on a suitable substrate to obtain a film of said composition;
c. cross-linking the carbon precursor;
d. subjecting the cross-linked carbon precursor-block copolymer composition to pyrolysis to produce a mesoporous metal nanoparticle-carbon hybrid comprising pores coated with said organometallic component.

21. A method of making a metal nanoparticle carbon hybrid comprising:
a. preparing a composition comprising a block copolymer, an organometallic compound, a carbon precursor, a catalyst and a suitable polar solvent;
b. forming droplets of said composition;
c. cross-linking the carbon precursor;
d. subjecting the cross-linked carbon precursor-block copolymer composition to pyrolysis to produce a mesoporous metal nanoparticle-carbon hybrid comprising pores coated with said organometallic component.

22. A method of making a metal nanoparticle carbon hybrid comprising
a. preparing a composition comprising a block copolymer, an organometallic compound, a oligomeric carbon precursor that is self-crosslinkable, and a suitable polar solvent;
b. dip-coating the surface of a non-planar specimen;
c. thermally crosslinking the carbon precursor; and
d. pyrolysing said crosslinked precursor to produce a mesoporous metal nanoparticle-carbon hybrid coating.

23. The method of claim 22 wherein said thermal cross linking comprises heating the coated specimen at 120° C. for a time sufficient to cross link said carbon precursor.

24. The method of claim 23 wherein said thermal cross linking further comprises exposing said composition to vapors of a reactive species.

25. A method of making a metal nanoparticle carbon hybrid comprising
a. preparing a composition comprising a block copolymer, an organometallic compound, a oligomeric carbon precursor that is self-crosslinkable, inorganic metal oxide nanoparticles, and a suitable polar solvent;
b. coating said composition onto a suitable surface;
c. crosslinking said carbon precursor; and
d. pyrolysing said crosslinked precursor to produce a mesoporous metal nanoparticle-carbon hybrid coating.
